(19) United States
(12) Patent Application Publication
(10) Pub. No.: US 2024/0339113 A1
(43) Pub. Date: Oct. 10, 2024

(54) SPEECH RECOGNITION DEVICE, SPEECH RECOGNITION METHOD, AND SPEECH RECOGNITION PROGRAM

(71) Applicant: NIPPON TELEGRAPH AND TELEPHONE CORPORATION, Tokyo (JP)

(72) Inventors: Takafumi MORIYA, Musashino-shi, Tokyo (JP); Takanori ASHIHARA, Musashino-shi, Tokyo (JP)

(73) Assignee: NIPPON TELEGRAPH AND TELEPHONE CORPORATION, Tokyo (JP)

(21) Appl. No.: 18/294,177

(22) PCT Filed: Aug. 5, 2021
(86) PCT No.: PCT/JP2021/029212

§ 371 Date: Feb. 1, 2024

(51) Int. Cl. G10L 15/22; G10L 25/30

(52) U.S. Cl. CPC G10L 15/22; G10L 25/30

(57) ABSTRACT

A speech recognition device includes a label estimation unit, a trigger-firing label estimation unit, and an RNN-T trigger estimation unit. The label estimation unit predicts a symbol sequence of the speech data based on an intermediate acoustic feature amount sequence and an intermediate symbol feature amount sequence of the speech data using a model learned by the RNN-T. The trigger-firing label estimation unit predicts a next symbol of the speech data using the attention mechanism based on the intermediate acoustic feature amount sequence of the speech data. The RNN-T trigger estimation unit calculates a timing at which a probability of occurrence of symbols other than a block in the speech data becomes a maximum based on a symbol sequence of the speech data predicted by the label estimation unit. Then, the RNN-T trigger estimation unit outputs the calculated timing as a trigger for operating the trigger-firing label estimation unit.

### TECHNICAL FIELD

The present invention relates to a speech recognition device, a speech recognition method, and a speech recognition program.

### BACKGROUND ART

Conventionally, there is an End-to-End speech recognition system that outputs arbitrary character sequences (for example, phonemes, characters, subwords, words, or the like) directly from acoustic features. As a learning method for this End-to-End speech recognition system, there is a learning method using a recurrent neural network transducer (RNN-T) (see NPL 1). Since the End-to-End speech recognition system learned by the RNN-T can be operated by frame-by-frame, streaming operation can be performed.

Also, there is a technique using an Attention-based Encoder-decoder as another End-to-End speech recognition system (refer to NPL 2). According to this technique, speech recognition can be performed with higher accuracy than the End-to-End speech recognition system learned using the RNN-T.

However, when speech recognition processing is performed in the technique, it is difficult to perform streaming operation because the speech recognition processing is performed using all of a series of intermediate outputs.

In view of this problem, there is a technique for performing a pseudo streaming operation of an Attention-based Encoder-Decoder (refer to NPL 3). According to this technique, an output can be obtained in frame-by-frame from the intermediate output of the Encoder via an output layer learned by a loss function of Connectionist Temporal Classification (CTC, see NPL 4). This output is similar to the output of the RNN-T, and the probability of a blank is high in a part where no characters are output, and the probability of a blank is lowered at the moment of outputting the corresponding phonemes, letters, sub words, word sequences, or the like.

In the above-described technique, the decoder is operated using the intermediate output of the encoder until the time when the probability of the block becomes lower than a predetermined threshold value by utilizing the characteristics of the CTC. Thus, the Attention-based Encoder-Decoder is operated in a pseudo manner in frame-by-frame, and the streaming operation can be performed.

### CITATION LIST

### Non Patent Literature

[NPL 1] Alex Graves, “Sequence Transduction with Recurrent Neural Networks,” in Proc. of ICML, 2012.
[NPL 2] J. Chorowski et. al., “Attention-based Models for Speech Recognition,” in Advances in NIPS, 2015, pp. 577-585.
[NPL 3] N. Moritz et. al., “TRIGGERED ATTENTION FOR END-TO-END SPEECH RECOGNITION,” in Proc. of ICASSP, 2019, pp. 5666-5670.
[NPL 4] A. Graves, et. al., “Connectionist Temporal Classification: Labelling Unsegmented Sequence Data with Recurrent Neural Networks,” in Proc. of ICML, 2006, pp. 369-376.

### SUMMARY OF INVENTION

### Technical Problem

Among the above techniques, an End-to-End speech recognition system learned by an RNN-T can perform a streaming operation, but there is a problem that the recognition accuracy of speech is lower than that of a technique using an Attention-based Encoder-Decoder. In addition, the technique using the Attention-based Encoder-Decoder has a problem that streaming operation is difficult although recognition accuracy is high.

Further, the technique for performing the pseudo streaming operation of the Attention-based Encoder-Decoder using the CTC has a problem that the operation timing of the decoder depends on the performance of the CTC.

Therefore, the object of the present invention is to solve the above-mentioned problems by making the operation timing of the decoder accurate when the End-to-End speech recognition system performs streaming operation, to improve speech recognition accuracy.

### Solution to Problem

In order to solve the above problem, the present invention includes a first decoder that predicts a symbol sequence of a speech signal based on an intermediate acoustic feature amount sequence and an intermediate symbol feature amount sequence of the speech signal to be recognized using a model learned by a recurrent neural network transducer (RNN-T), a second decoder that predicts a next symbol of the speech signal using an attention mechanism based on the intermediate acoustic feature amount sequence of the speech signal, and a trigger output unit that calculates a timing at which a probability that a symbol other than a block will occur in the speech signal becomes a maximum based on the symbol sequence of the speech signal predicted by the first decoder, and outputs the calculated timing as a trigger for operating the second decoder.

### Advantageous Effects of Invention

According to the present invention, it is possible to make the operation timing of the decoder accurate when the End-to-End speech recognition system performs the streaming operation, and to improve the recognition accuracy of the speech.

### BRIEF DESCRIPTION OF DRAWINGS

FIG. 1 is a diagram illustrating a configuration example of a speech recognition device that is a basic technology of a speech recognition device according to the present embodiment.

FIG. 2 is a diagram illustrating a configuration example of a speech recognition device that is a basic technology of a speech recognition device according to the present embodiment.

FIG. 3 is diagram illustrating an example of a CTC path.

FIG. 4 is a diagram illustrating a configuration example of the speech recognition device according to the present embodiment.

FIG. 5 is a diagram illustrating an example of a maximum likelihood path in RNN-T.

FIG. 6 is a diagram illustrating the maximum likelihood path illustrated in FIG. 5, where the laterally moving blank path is removed.

FIG. 7 is a diagram illustrating points corresponding to the maximum value among points corresponding to each symbol illustrated in FIG. 6.

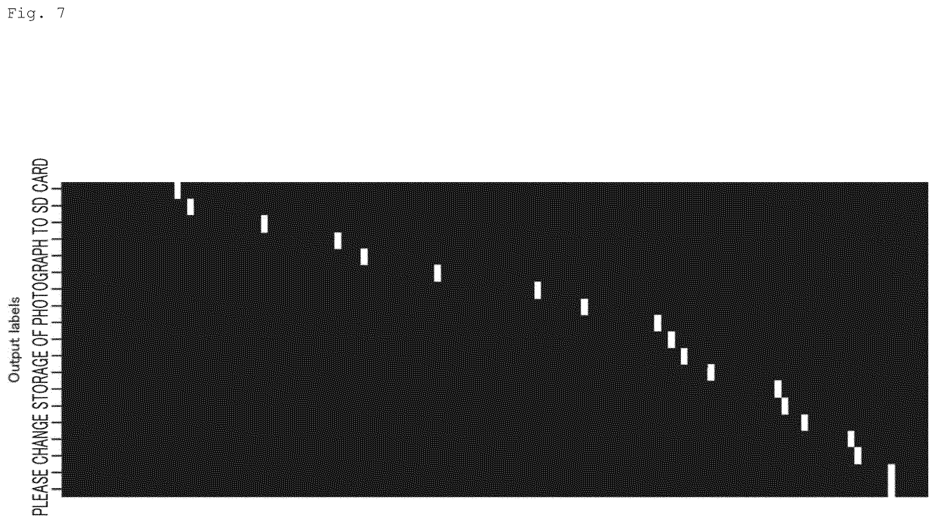

FIG. 8 is a diagram illustrating an example of a range of frames used for calculating attention α by a trigger-firing label estimation unit illustrated in FIG. 4.

FIG. 9 is a diagram illustrating an example of a range of frames used for calculating attention α by the trigger-firing label estimation unit illustrated in FIG. 4.

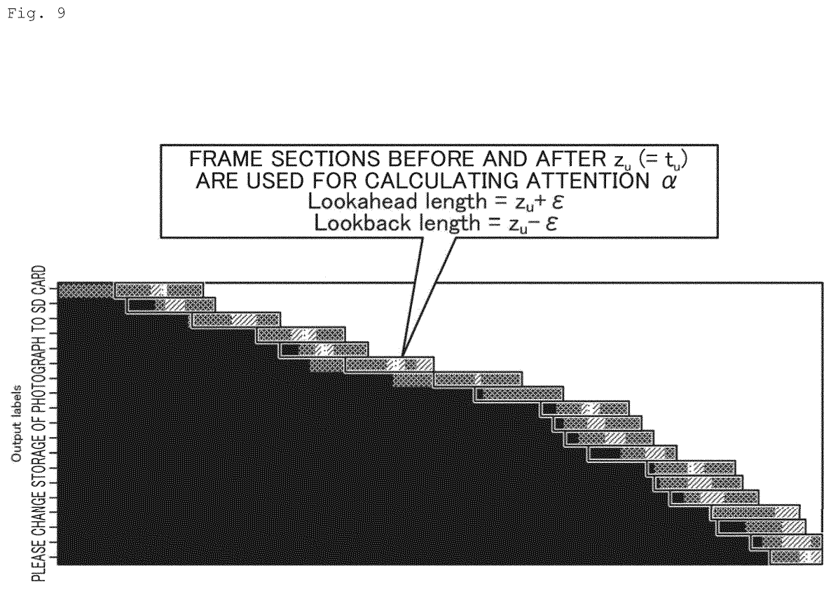

FIG. 10 is a flowchart illustrating an example of a processing procedure of the speech recognition device of the present embodiment.

FIG. 11 is a diagram illustrating a configuration example of a computer that executes a speech recognition program.

### DESCRIPTION OF EMBODIMENTS

Modes (embodiments) for carrying out the present invention will be described below with reference to the drawings. First, a basic technology of a speech recognition device of the present embodiment will be described. The first basic technique is a speech recognition device 1 that performs speech recognition processing of speech data by an RNN-T. The second basic technique is a speech recognition device 1a that performs a pseudo streaming operation of an Attention-based Encoder-Decoder using CTC. The speech recognition devices 1 and 1a are speech recognition devices that perform speech recognition of End-to-End.

### [Speech Recognition Device 1]

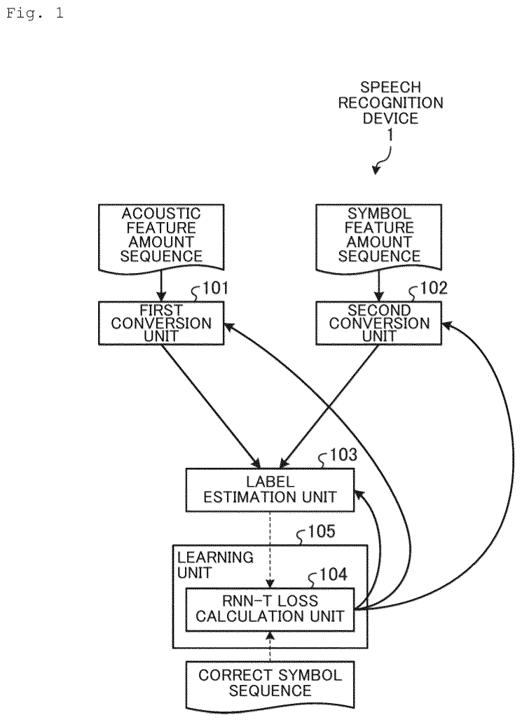

The speech recognition device 1 will be described with reference to FIG. 1. When an acoustic feature amount sequence and a symbol sequence of speech data to be recognized are input, the speech recognition device 1 outputs an estimation value (output probability distribution of the label) of the label of the symbol sequence of the speech data.

The speech recognition device 1 includes a first conversion unit 101, a second conversion unit 102, a label estimation unit 103, and a learning unit 105. The learning unit 105 includes an RNN-T loss calculation unit 104.

### [First Conversion Unit 101]

Input: Acoustic feature amount sequence X
Output: Intermediate acoustic feature amount sequence H
Processing: The first conversion unit 101 is an encoder that converts an input acoustic feature amount X into an intermediate acoustic feature amount sequence H using a multi-stage neural network.

### [Second Conversion Unit 102]

Input: Symbol sequence c (Length U)
Output: Intermediate character feature amount sequence C (length U)
Processing: The second conversion unit 102 is an encoder that converts an input symbol sequence c into a feature amount of a corresponding continuous value. For example, the second conversion unit 102 converts the input symbol sequence c into a one-hot vector, and then converts the vector into an intermediate character feature amount sequence C by a multi-stage neural network.

### [Label Estimation Unit 103]

Input: Intermediate acoustic feature amount sequence H, Intermediate character feature amount sequence C (Length U)
Output: Output probability distribution Y
Processing: The label estimation unit 103 calculates and outputs an output probability distribution Y of a label of a symbol of speech data by a neural network from the intermediate acoustic feature amount sequence H and the intermediate character feature amount sequence C.

For example, the label estimation unit 103 calculates output probabilities y_{t,u} of the label of the symbol of the speech data using a soft max function shown in Equation (1) below.

$${y}_{t , u} = Softmax ( {W}_{3} ( tanh ( {W}_{1} {h}_{t} + {W}_{2} {C}_{u} + b ) ) \qquad Equation ( 1 )$$

In a case where the dimensions of t and u are different from each other, the dimensions of the number of elements of the neural network are three-dimensional, in addition to t and u.

Specifically, at the time of adding by the label estimation unit 103 based on Equation (1) above, W₁H is extended by copying the same value in the dimensional direction of U, and W₂C is extended by copying the same value in the dimensional direction of T in the same manner to arrange dimensions, and then three-dimensional tensors are added to each other. Therefore, the output is also a 3D tensor.

In general, at the time of RNN-T learning, model learning is performed according to the RNN-T loss on the assumption that output becomes a three-dimensional tensor. In addition, at the time of the label estimation by the label estimation unit 103, since there is no expansion operation, the output is a two-dimensional matrix.

### [RNN-T Loss Calculation Unit 104]

Input: Output probability distribution Y (Three-dimensional tensor), Correct symbol sequence c (Length U)
Output: Loss L_{RNN-T}
Processing: As illustrated in FIG. 1, the RNN-T loss calculation unit 104 calculates a loss L_{RNN-T} based on the output probability distribution Y output by the label estimation unit 103 and the correct symbol sequence c.

For example, the RNN-T loss calculation unit 104 calculates the path of optimal transition probability in a UXT plane based on a forward-backward algorithm in a tensor with a vertical axis U (symbol sequence length), a horizontal axis T (input sequence length), and a depth K (number of classes: number of symbol entries). Then, the RNN-T loss calculation unit 104 calculates the loss L_{RNN-T} using the path of the optimum probability transition obtained by the calculation.

The detailed process of the above calculation is described in the “2. Recurrent Neural Network Transducer” of NPL 1.

### [Learning Unit 105]

The learning unit 105 updates parameters of the first conversion unit 101, the second conversion unit, and the label estimation unit 103 using the loss L_{RNN-T} calculated by the RNN-T loss calculation unit 104.

[Speech Recognition Device 1a]

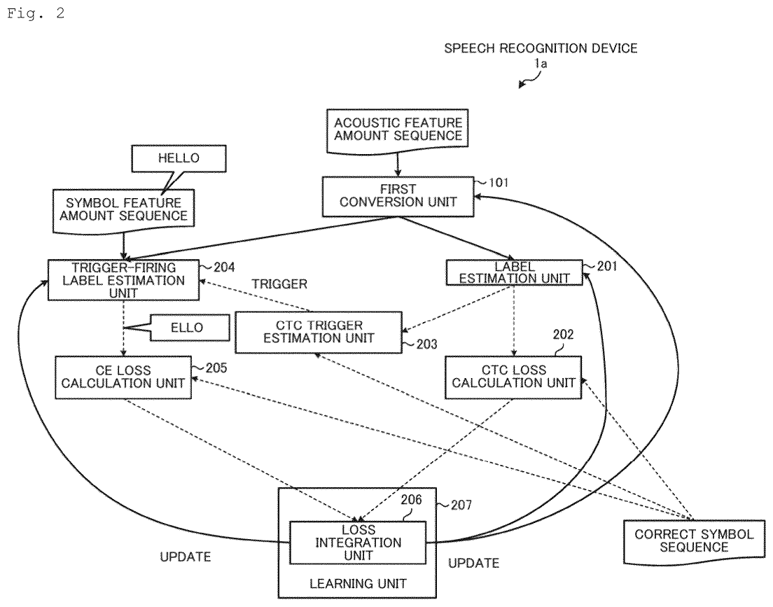

Next, the speech recognition device 1a will be described with reference to FIG. 2. The speech recognition device 1a also inputs the acoustic feature amount sequence and the symbol sequence of the speech data to be recognized, and outputs the estimated value (output probability distribution of the label) of the symbol sequence of the speech data. The speech recognition device 1a uses the CTC to cause an Attention-based Encoder-Decoder perform a pseudo streaming operation. The same components as those of the speech recognition device 1 described above are denoted by the same reference numerals, and descriptions thereof are omitted.

The speech recognition device 1a includes the first conversion unit 101, the label estimation unit 103, a CTC loss calculation unit 202, a CTC trigger estimation unit 203, a trigger-firing label estimation unit 204, a CE loss calculation unit 205, and a learning unit 207. The learning unit 207 includes a loss integration unit 206.

### [Label Estimation Unit 201]

Input: Intermediate acoustic feature amount sequence H
Output: Output probability distribution Y′
Processing: A label estimation unit 201 uses the intermediate acoustic feature amount sequence H up to a time 1-T to obtain an output probability distribution Y′ of the label of the symbol based on Equation (2) below.

$${y}_{t} = Softmax ( {Wh}_{t} + b ) \qquad Equation ( 2 )$$

As shown in the above equation, the CTC is different from the RNN-T, and the output becomes a two-dimensional matrix in both the learning of the parameter of the model and the estimation using the model. The parameters to learn are W and b.

### [CTC Loss Calculation Unit 202]

Input: Output probability distribution Y, Correct symbol sequence c (Length U)
Output: Loss L-re
Processing: The CTC loss calculation unit 202 uses the output probability distribution Y′ output from the label estimation unit 201 and the correct symbol sequence c to calculate the loss L_{CTC}. For example, the CTC loss calculation unit 202 calculates a maximum likelihood path from an output matrix which is an output probability sequence obtained by the label estimation unit 201 using a forward-backward algorithm. Then, the CTC loss calculation unit 202 calculates the loss L_{CTC} using the calculated maximum likelihood path. For example, the CTC loss calculation unit 202 calculates the loss L_{CTC} by the method described in NPL 4.

### [CTC Trigger Estimation Unit 203]

Input: Output probability distribution Y′, Correct symbol sequence c (Length U)
Output: Trigger Z.
Processing: The CTC trigger estimation unit 203 is similar to the CTC loss calculation unit 202, and calculates the maximum likelihood path from an output matrix which is an output probability sequence output from the label estimation unit 201 using a forward-backward algorithm.

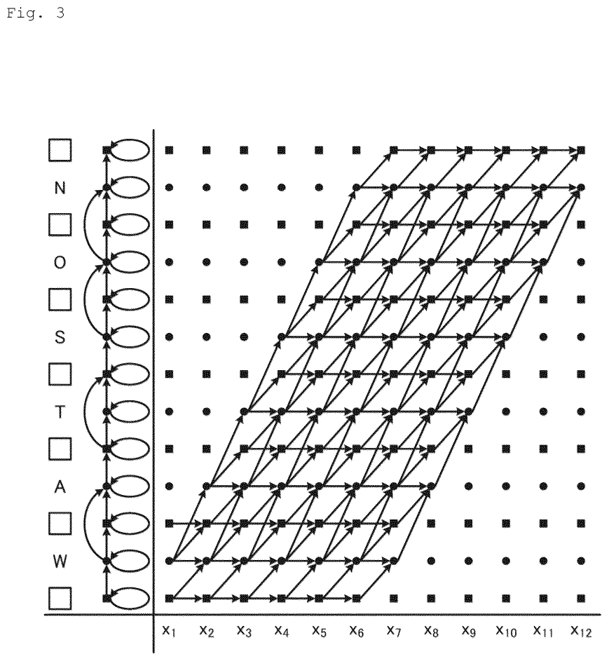

FIG. 3 is an image diagram of the path of the CTC. The CTC trigger estimation unit 203 extracts the position of the smallest index (symbol arranged on the vertical axis of FIG. 3) among the positions in the time direction (corresponding to the horizontal axis of FIG. 3) in which each correct symbol is generated in the maximum likelihood path calculated using the forward-backward algorithm. Then, the CTC trigger estimation unit 203 outputs the extracted position as a position (=trigger Z) where the symbol occurs.

### [Trigger-Firing Label Estimation Unit 204]

Input: Intermediate acoustic feature amount sequence H, Correct symbol sequence c (length U), Trigger Z
Output: Output probability distribution Y″
Processing: The trigger-firing label estimation unit 204 is a trigger-firing label estimation unit with an attention mechanism. The trigger-firing label estimation unit 204 uses the symbol (for example, “HELLO”) and the intermediate acoustic feature amount sequence H, which is a high-order acoustic feature based on the trigger Z to calculate the output probability distribution Y″ of the label of the next symbol (for example, “ELLO”).

Note that the label estimation unit with an attention mechanism (Attention-based Encoder-decoder) that does not use a trigger, described in NPL 2, operates based on Equations (1) to (9) of NPL 2, for example. For the calculation of attention (Equation (1) in NPL 2), the label estimation unit with attention mechanism needs to use the entire intermediate acoustic feature amount sequence H from the beginning to the end of the speech (the time index is described as L in NPL 2). Therefore, the label estimation unit with the attention mechanism is difficult to perform streaming operation.

In response to this problem, the trigger-firing label estimation unit 204 performs a pseudo streaming operation using the framework of NPL 3. Therefore, Equations (1) and (2) of NPL 2 are defined as Equations (8) and (9) of NPL 3.

Specifically, the trigger-firing label estimation unit 204 calculates Equations (8) and (9) of NPL 3 using the trigger Z as τᵤ(τ=zᵤ+ε) (in NPL 3, the above u is described as 1). This means that the trigger-firing label estimation unit 204 calculates an attention α using the intermediate acoustic feature amount sequence H from the first to a u-th trigger point Zᵤ when predicting a u-th symbol. Thus, since the trigger-firing label estimation unit 204 operates each time the trigger Z is generated, pseudo streaming operation becomes possible.

### [CE Loss Calculation Unit 205]

Input: Output probability distribution Y″, Correct symbol sequence c (Length U)
Output: Loss L_{CE}
Processing: The CE loss calculation unit 205 calculates the loss L_{CE} using the prediction result of the next symbol (output probability distribution Y″) and the correct symbol sequence c. This loss L_{CE} is calculated by a simple cross entropy loss.

### [Loss Integration Unit 206]

Input: Loss L_{CE}, Loss L_{CTC}, Hyper parameter ρ (0<ρ<1)
Output: Loss L
Processing: The loss integration unit 206 weights the losses obtained by the respective loss calculation units (the CTC loss calculation unit 202 and the CE loss calculation unit 2205) by the hyper parameter ρ, respectively, and calculates the integrated loss L (Equation (3)).

$$L = ( 1 - ρ ) {L}_{CE} + ρ {L}_{CTC} \qquad Equation ( 3 )$$

### [Learning Unit 207]

The learning unit 207 performs learning (parameter update) of the first conversion unit 101, the label estimation unit 201 and the trigger-firing label estimation unit 204 based on the loss L calculated by the loss integration unit 206.

[Speech Recognition Device 1b]

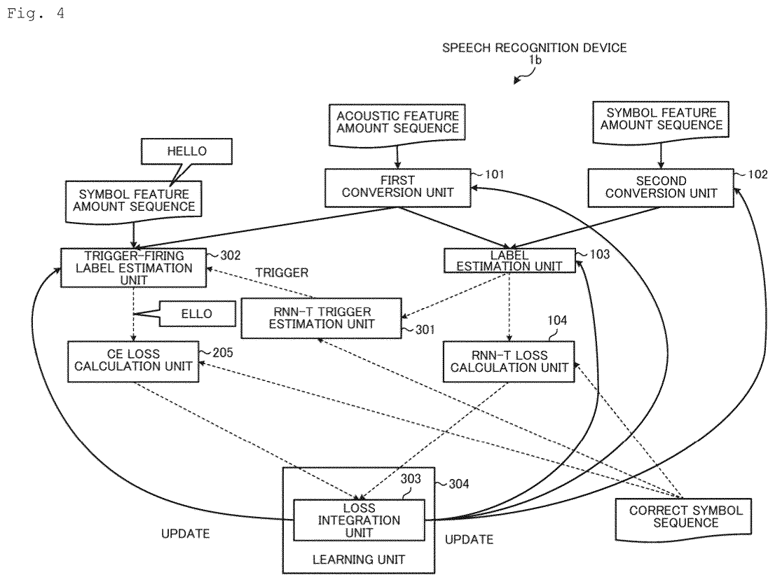

Next, a speech recognition device 1b will be described with reference to FIG. 4. The same components as those of the speech recognition devices 1 and 1a described above are denoted by the same reference numerals, and descriptions thereof are omitted.

The difference from the speech recognition device 1 is that the speech recognition device 1b utilizes the trigger-firing label estimation unit for predicting symbols and learning models. The difference from the speech recognition device 1a is that the speech recognition device 1b uses the output of the RNN-T for estimating the trigger and that the trigger-firing label estimation unit is operated at high speed (details will be described later).

According to the speech recognition device 1b, the operation timing of a decoder (trigger-firing label estimation unit) in streaming operation can be made more accurate and the recognition accuracy of speech can be improved than in the case of using the CTC like the speech recognition device 1a.

The speech recognition device 1b includes, as illustrated in FIG. 4, the first conversion unit 101, the second conversion unit 102, the label estimation unit (first decoder) 103, the RNN-T loss calculation unit 104, the CE loss calculation unit 205, an RNN-T trigger estimation unit 301, a trigger-firing label estimation unit (second decoder) 302, and a learning unit 304. The learning unit 304 includes a loss integration unit 303.

### [RNN-T Trigger Estimation Unit 301]

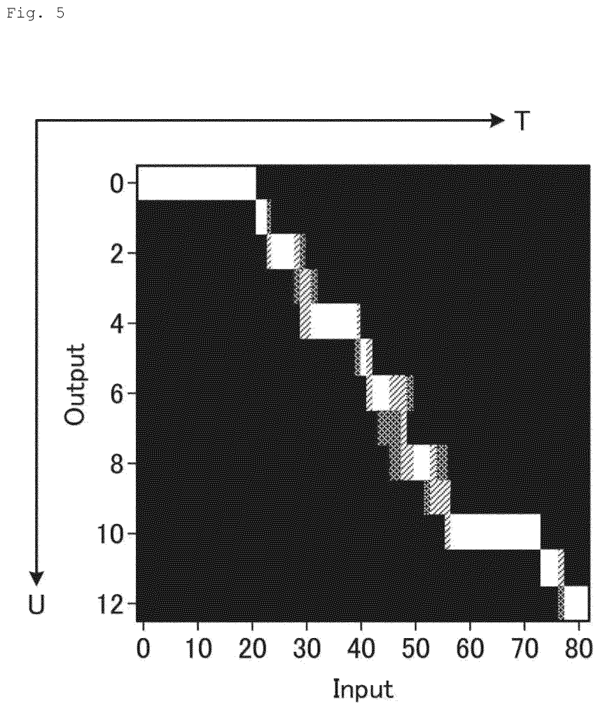

Input: Output probability distribution Y, Correct symbol sequence c (Length U)
Output: Trigger Z′
Processing: The RNN-T trigger estimation unit 301 calculates a maximum likelihood path from a three-dimensional output tensor which is an output probability sequence obtained by the label estimation unit 103 using a forward-backward algorithm. For example, the RNN-T trigger estimation unit 301 calculates the maximum likelihood path illustrated in FIG. 5 from the output probability distribution Y. In FIG. 5, the vertical axis is U, and the horizontal axis is T. In the maximum likelihood path, when moving in the horizontal axis direction, it indicates that a blank is output, and when moving in the vertical axis direction, it indicates that a correct symbol is output.

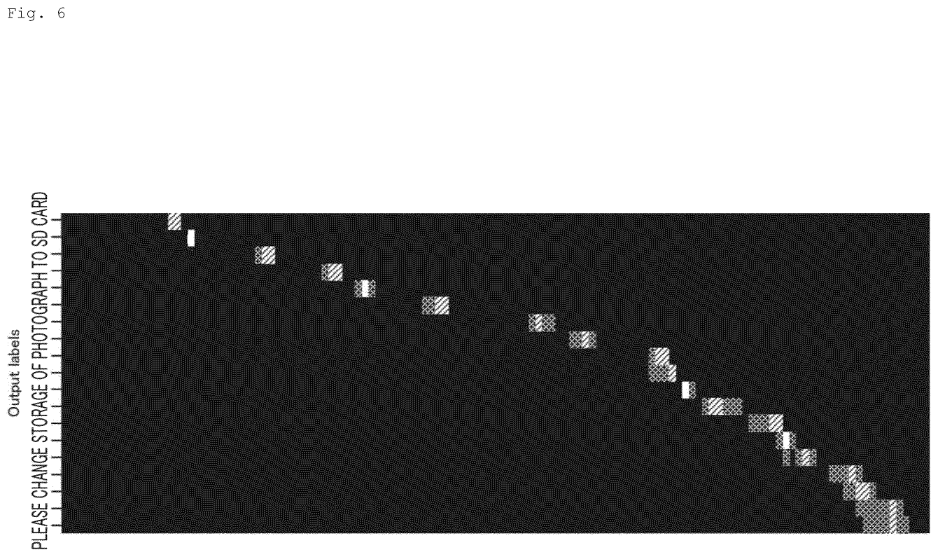

FIG. 6 illustrates the maximum likelihood path illustrated in FIG. 5 except for the blank path moving in the horizontal axis direction. Each point (void portion) in FIG. 6 represents a predicted value of the timing at which the next symbol occurs. The RNN-T trigger estimation unit 301 outputs, as a trigger, a time index of a point at which a probability value of occurrence of the symbol becomes a maximum among points corresponding to each symbol illustrated in FIG. 6. The RNN-T trigger estimation unit 301 sets a time index of a point where a probability value becomes a maximum among points corresponding to the correct symbol sequence c in learning as a trigger Z of each correct symbol.

### [Trigger-Firing Label Estimation Unit 302]

Input: Intermediate acoustic feature amount sequence H, Correct symbol sequence c (Length U), Trigger Z′
Output: Output probability distribution Y″
Processing: The trigger-firing label estimation unit 302 is similar to the trigger-firing label estimation unit 204 (see FIG. 2), but differs in that the trigger-firing label estimation unit 302 uses the intermediate acoustic feature amount sequence H to calculate the output probability distribution Y″ of the label of the next symbol (for example, “ELLO”) based on the trigger Z′ output by the RNN-T trigger estimation unit 301.

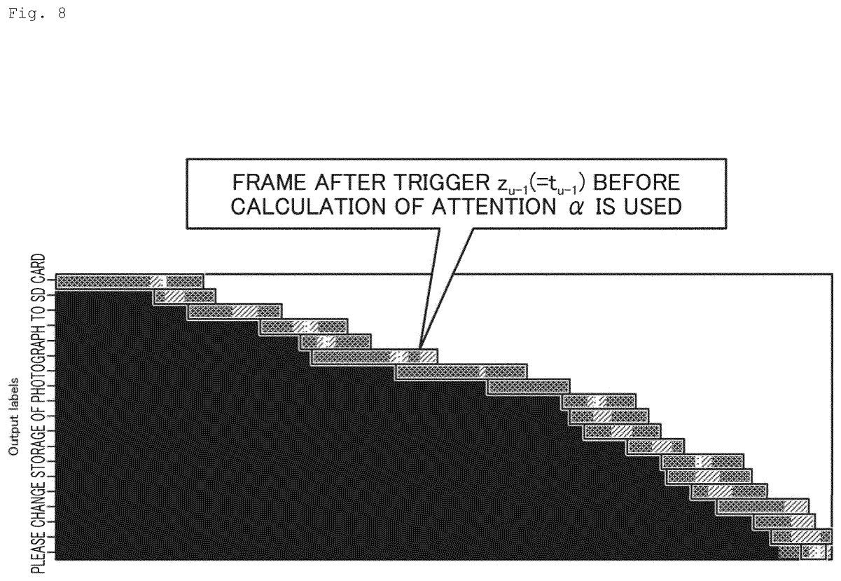

In addition, the trigger-firing label estimation unit 302 uses frames after the previous trigger zᵤ₋₁(=tᵤ₋₁) for calculating the attention α in Equations (8) and (9) of NPL 3 (see FIG. 8).

In addition, the trigger-firing label estimation unit 302 may use a predetermined number of frame sections (Lookahead length=zᵤ+ε, Lookback length=zᵤ−ε, ε: hyperparameters that can be set arbitrarily) before and after the trigger zᵤ to calculate attention α in Equations (8) and (9) of NPL 3.

The trigger-firing label estimation unit 302 calculates the attention α by each of the above calculation methods, so that the memory can be saved and the operation can be performed at a high speed. As a result, the speech recognition device 1b can perform high-speed streaming operation.

Since the output probability distribution Y″, which is output by the trigger-firing label estimation unit 302, is similar to the output probability distribution Y″, which is output by the trigger-firing label estimation unit 204 (see FIG. 2), the loss can be calculated by the CE loss calculation unit 205.

### [Loss Integration Unit 303]

Input: Loss L_{CE}, Loss L_{RNN-T}, and Hyper parameter λ (0λ1)
Output: Loss L
Processing: The loss integration unit 303 integrates the losses obtained by the respective loss calculation units (RNN-T loss calculation unit 104 and CE loss calculation unit 205) by a weighted sum by the hyper parameter A, and calculates the loss L (Equation (4)).

$$L = ( 1 - λ ) {L}_{CE} + λ {L}_{RNN - T} \qquad Equation ( 4 )$$

### [Learning Unit 304]

The learning unit 304 performs learning (parameter update) of the first conversion unit 101, the second conversion unit 102, the label estimation unit 103, and the trigger-firing label estimation unit 302 based on the loss L calculated by the loss integration unit 303.

Here, the learning unit 304 first learns, for example, each unit (the first conversion unit 101, the second conversion unit 102, and the label estimation unit 103) using the RNN-T, and after fixing the parameter of each unit, may learn the trigger-firing label estimation unit 302. For example, the learning unit 304 substitutes λ=1 in Equation (4) above to learn the first conversion unit 101, the second conversion unit 102, and the label estimation unit 103, and then, performs the learning of the trigger-firing label estimation unit 302 by substituting λ=0.

The learning unit 304 learns in the manner described above, so that the RNN-T trigger estimation unit 301 can output an accurate trigger. Thus, the learning unit 304 can learn the trigger-firing label estimation unit 302 using an accurate trigger. As a result, the learning unit 304 can improve the estimation accuracy by the trigger-firing label estimation unit 302. That is, the recognition accuracy of the speech in the speech recognition device 1b can be improved.

### Example of Processing Procedure

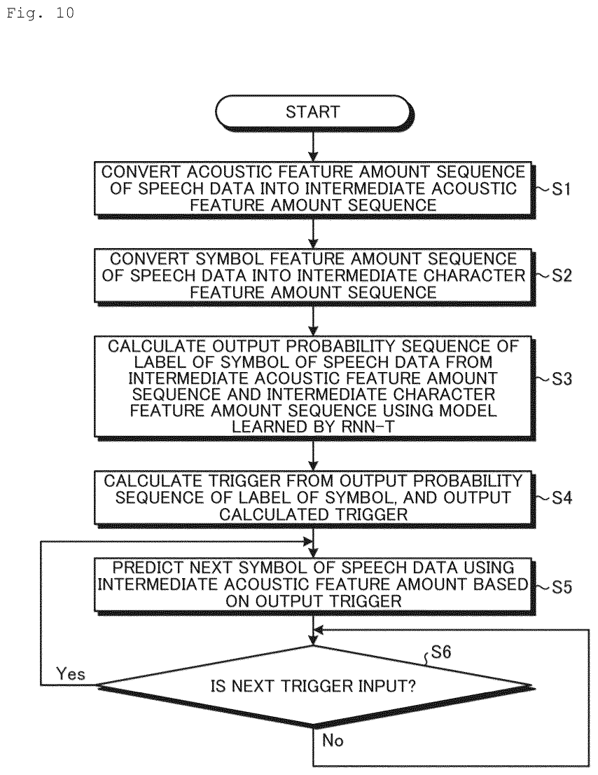

Next, an example of the processing procedure of the speech recognition device 1b after learning will be described with reference to FIG. 10. When the speech recognition device 1b receives the input of speech data to be speech-recognized, the following processing is performed. First, the first conversion unit 101 converts the acoustic feature amount sequence of input speech data into the intermediate acoustic feature amount sequence (S1). The second conversion unit 102 converts the symbol feature amount sequence of the input speech data into the intermediate character feature amount sequence (S2).

Thereafter, the label estimation unit 103 calculates the output probability sequence of the label of the symbol of speech data from the intermediate acoustic feature amount sequence and the intermediate character feature amount sequence using a model learned by the RNN-T (S3).

Thereafter, the RNN-T trigger estimation unit 301 calculates a timing at which the probability of occurrence of a symbol other than a block in the speech data becomes a maximum from the output probability sequence of the label of the symbol of the speech data calculated in S3, and outputs the result as a trigger for operating the trigger-firing label estimation unit 302 (S4: calculating the trigger from the output probability sequence of the symbol, and outputting the calculated trigger).

The trigger-firing label estimation unit 302 predicts a symbol of speech data using the intermediate acoustic feature amount sequence based on the trigger output from the RNN-T trigger estimation unit 301 (S5). Thereafter, when the next trigger is inputted from the RNN-T trigger estimation unit 301 by the trigger-firing label estimation unit 302 (Yes in S6), the processing of S5 is executed. On the other hand, when there is no input of the next trigger from the RNN-T trigger estimation unit 301 (No in S6), the trigger-firing label estimation unit 302 returns to S6 and waits for the input of the next trigger.

Thus, the speech recognition device 1b can perform speech recognition of the speech data by streaming operation.

### [System Configuration, or the Like]

Each constituent of each of the illustrated units is simply functionally conceptual and need not necessarily be physically configured as illustrated in the drawings. In other words, the specific forms of dispersion and integration of each apparatus are not limited to those illustrated in the drawings and all of or a part of the apparatus may be functionally or physically distributed or integrated in any unit depending on various loads, usage conditions, or the like. Further, some or all of the units of each processing function performed in each device can be implemented by a CPU and a program executed by the CPU, or can be implemented as hardware by a wired logic.

Also, out of the steps of processing described in the foregoing embodiment, all or some of the steps of processing described as being automatically executed may also be manually executed. Alternatively, all or some of the steps of processing described as being manually executed may also be automatically executed using a known method. In addition, the processing procedure, the control procedure, specific names, information including various types of data and parameters that are shown in the above document and drawings may be arbitrarily changed unless otherwise described.

### [Program]

The speech recognition device 1b described above can be implemented by installing the program (speech recognition program) in a desired computer as package software or on-line software. For example, by causing the information processing device to execute the above program, the information processing device can be made to function as the speech recognition device 1b. The information processing device which is described here includes a mobile communication terminal such as a smart phone, a mobile phone, and a personal handyphone system (PHS), and further includes a terminal such as personal digital assistant (PDA) in its category.

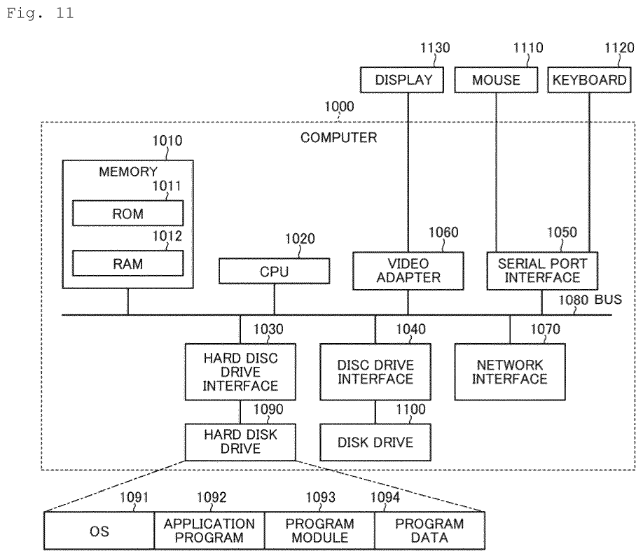

FIG. 11 is a diagram illustrating an example of a computer that executes a speech recognition program. A computer 1000 includes, e.g., a memory 1010 and a CPU 1020. Further, the computer 1000 also includes a hard disk drive interface 1030, a disk drive interface 1040, a serial port interface 1050, a video adapter 1060, and a network interface 1070. These units are connected to one another via a bus 1080.

The memory 1010 includes a read only memory (ROM) 1011 and a random access memory (RAM) 1012. The ROM 1011 stores, for example, a boot program, such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each processing executed by the speech recognition device 1b is mounted as the program module 1093 in which codes that can be executed by a computer are described. The program module 1093 is stored in, for example, the hard disk drive 1090. For example, the program module 1093 executing similar processing to the functional configuration of the speech recognition device 1b is stored in the hard disk drive 1090. The hard disk drive 1090 may be replaced with a solid-state drive (SSD).

Data used for the processing of the above-described embodiment is stored, for example, in the memory 1010 or the hard disk drive 1090 as the program data 1094. The CPU 1020 reads the program module 1093 and the program data 1094 stored in the memory 1010 or the hard disk drive 1090 onto the RAM 1012 and executes them as necessary.

The program module 1093 and the program data 1094 are not limited to being stored in the hard disk drive 1090 and may also be stored in, for example, a removable storage medium and may be read out by the CPU 1020 via the disk drive 1100 or the like. Alternatively, the program module 1093 and the program data 1094 may be stored in another computer connected via a network (a local area network (LAN)), a wide area network (WAN), or the like). The program module 1093 and the program data 1094 may be read by the CPU 1020 from the other computer via the network interface 1070.

### REFERENCE SIGNS LIST

1, 1a, 1b Speech recognition device
101 First conversion unit
102 Second conversion unit
103, 201 Label estimation unit
104 RNN-T loss calculation unit
202 CTC loss calculation unit
203 CTC trigger estimation unit
204, 302 Trigger-firing label estimation unit
205 CE loss calculation unit
206, 303 Loss integration unit
207, 304 Learning unit
301 RNN-T trigger estimation unit

1. A speech recognition device, comprising:
a first decoder that predicts a symbol sequence of a speech signal based on an intermediate acoustic feature amount sequence and an intermediate symbol feature amount sequence of the speech signal to be recognized using a model learned by a recurrent neural network transducer (RNN-T);
a second decoder that predicts a next symbol of the speech signal using an attention mechanism based on the intermediate acoustic feature amount sequence of the speech signal; and
trigger output circuitry that calculates a timing at which a probability that a symbol other than a block will occur in the speech signal becomes a maximum based on the symbol sequence of the speech signal predicted by the first decoder, and outputs the calculated timing as a trigger for operating the second decoder.

2. The speech recognition device according to claim 1, wherein;
the second decoder estimates the next symbol using an intermediate acoustic feature amount sequence after a point corresponding to a timing at which the second decoder operated last time among the intermediate acoustic feature amount sequences of the speech signal.

3. The speech recognition device according to claim 1, wherein;
the second decoder estimates the next symbol using an intermediate acoustic feature amount sequence in a predetermined section before and after a point corresponding to a timing at which the second decoder operates this time among the intermediate acoustic feature amount sequences of the speech signal.

4. The speech recognition device according to claim 1, further comprising:
learning circuitry that determines parameters of models used by the first decoder and the second decoder using a correct symbol sequence to the speech signal as learning data.

5. The speech recognition device according to claim 4, wherein:
the learning circuitry, after determining the parameter of the model used by the first decoder, determines the parameter of the model used by the second decoder.

6. A speech recognition method, comprising:
predicting a symbol sequence of a speech signal based on an intermediate acoustic feature amount sequence and an intermediate symbol feature amount sequence of the speech signal to be recognized using a model learned by a recurrent neural network transducer (RNN-T);
predicting a next symbol of the speech signal using an attention mechanism based on the intermediate acoustic feature amount sequence of the speech signal; and
calculating a timing at which a probability that a symbol other than a block occurs in the speech signal becomes a maximum based on the symbol sequence of the speech signal predicted in the predicting the symbol sequence, and outputting the calculated timing as a trigger for executing the predicting the next symbol.

7. A non-transitory computer readable medium storing a speech recognition program for causing a computer to execute:
predicting a symbol sequence of a speech signal based on an intermediate acoustic feature amount sequence and an intermediate symbol feature amount sequence of the speech signal to be recognized using a model learned by a recurrent neural network transducer (RNN-T);
predicting a next symbol of the speech signal using an attention mechanism based on the intermediate acoustic feature amount sequence of the speech signal; and
calculating a timing at which a probability that a symbol other than a block occurs in the speech signal becomes a maximum based on the symbol sequence of the speech signal predicted in the predicting the symbol sequence, and outputting the calculated timing as a trigger for executing the predicting the next symbol.
